(19) United States
(12) Patent Application Publication
(10) Pub. No.: US 2024/0386218 A1
(43) Pub. Date: Nov. 21, 2024

(54) SYSTEMS AND METHODS TO BUILD ONEQG: A UNIFIED QUESTION GENERATION SYSTEM ACROSS MODALITIES

(71) Applicant: International Business Machines Corporation, Armonk, NY (US)

(72) Inventors: Vishwajeet Kumar, Bangalore (IN); Jaydeep Sen, Bangalore (IN); Saneem Ahmed Chemmengath, Bangalore (IN); Rudra V Murthy, Bangalore (IN)

(21) Appl. No.: 18/317,703

(22) Filed: May 15, 2023

(51) Int. Cl. G06F 40/42; G06F 16/2452

(52) U.S. Cl. CPC G06F 40/42; G06F 16/24522

(57) ABSTRACT

One or more systems, devices, computer program products and/or computer-implemented methods of use provided herein relate to building a unified question generation system across languages and modalities. The computer-implemented system can comprise a memory that can store computer executable components. The computer-implemented system can further comprise a processor that can execute the computer executable components stored in the memory, wherein the computer executable components can comprise a training component that can train a unified question generation model to generate questions in a language from a first modality in the language using training data comprising one or more second modalities in the language different from the first modality, wherein the first modality and the one or more second modalities can include at least one of one or more tables, one or more passages, or a combination of the one or more tables and the one or more passages.

### BACKGROUND

The subject disclosure relates to machine learning and, more specifically, to building a unified question generation system across languages and modalities.

### SUMMARY

The following presents a summary to provide a basic understanding of one or more embodiments described herein. This summary is not intended to identify key or critical elements, delineate scope of particular embodiments or scope of claims. Its sole purpose is to present concepts in a simplified form as a prelude to the more detailed description that is presented later. In one or more embodiments described herein, systems, computer-implemented methods, apparatus and/or computer program products that enable generation of a unified question generation system across languages and modalities are discussed.

According to an embodiment, a computer-implemented system is provided. The computer-implemented system can comprise a memory that can store computer executable components. The computer-implemented system can further comprise a processor that can execute the computer executable components stored in the memory, wherein the computer executable components can comprise a training component that can train a unified question generation model to generate questions in a language from a first modality in the language using training data comprising one or more second modalities in the language different from the first modality, wherein the first modality and the one or more second modalities can include at least one of one or more tables, one or more passages, or a combination of the one or more tables and the one or more passages.

According to another embodiment, a computer-implemented method is provided. The method can comprise training, by a system operatively coupled to a processor, a unified question generation model to generate questions in a language from a first modality in the language using training data comprising one or more second modalities in the language different from the first modality, wherein the first modality and the one or more second modalities can include at least one of one or more tables, one or more passages, or a combination of the one or more tables and the one or more passages.

According to yet another embodiment, a computer program product for unified question generation to generate multilingual and multimodal questions is provided. The computer program product can comprise a computer readable storage medium having program instructions embodied therewith, the program instructions executable by a processor to cause the processor to train, by the processor, a unified question generation model to generate questions in a language from a first modality in the language using training data comprising one or more second modalities in the language different from the first modality, wherein the first modality and the one or more second modalities can include at least one of one or more tables, one or more passages, or a combination of the one or more tables and the one or more passages.

### BRIEF DESCRIPTION OF THE DRAWINGS

FIG. 1 illustrates a block diagram of an example, non-limiting system that can build a unified question generation system for generating multilingual and multimodal questions in accordance with one or more embodiments described herein.

FIG. 2 illustrates an example, non-limiting pipeline for building a unified question generation system that can generate multilingual and multimodal questions in accordance with one or more embodiments described herein.

FIG. 3 illustrates an example, non-limiting unified graph of a unified graph representation in accordance with one or more embodiments described herein.

FIG. 4 illustrates example, non-limiting pipelines for building a unified question generation system that can generate multilingual and multimodal questions in accordance with one or more embodiments described herein.

FIG. 5 illustrates an example, non-limiting embodiment for training a unified question generation model in accordance with one or more embodiments described herein.

FIG. 6 illustrates an example, non-limiting pipeline for building a unified question generation system that can generate multilingual and multimodal questions in accordance with one or more embodiments described herein.

FIG. 7 illustrates an example, non-limiting embodiment for building a unified question generation system that can generate multilingual and multimodal questions in accordance with one or more embodiments described herein.

FIG. 8 illustrates an example, non-limiting embodiment for building a unified question generation system that can generate multilingual and multimodal questions in accordance with one or more embodiments described herein.

FIG. 9 illustrates an example, non-limiting embodiment of a HybridQA dataset in accordance with one or more embodiments described herein.

FIG. 10 illustrates a flow diagram of an example, non-limiting method for generating questions from hybrid chains in accordance with one or more embodiments described herein.

FIG. 11 illustrates an example, non-limiting model for generating multilingual questions from a table in accordance with one or more embodiments described herein.

FIG. 12 illustrates an example, non-limiting method for building a unified question generation model to generate multilingual and multimodal questions in accordance with one or more embodiments described herein.

FIG. 13 illustrates an example, non-limiting method for enabling a first architecture for training a unified question generation model to generate multilingual and multimodal questions in accordance with one or more embodiments described herein.

FIG. 14 illustrates a flow diagram of an example, non-limiting method for enabling a second architecture for training a unified question generation model to generate multilingual and multimodal questions in accordance with one or more embodiments described herein.

FIG. 15 illustrates a block diagram of an example, non-limiting operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

Question generation is the task of generating meaningful questions given a context comprising answers to the questions. Techniques employed for question generation tasks can generate questions independently over tables or passages, and multilingual language models can generate reasonably well multilingual questions over passages. Such systems/techniques can also enable multilingual transfer by using a multilingual transformer (e.g., mT5 model), and multimodal but monolingual question generation can also be possible. However, such systems/techniques are often unable to generate multilingual questions over a combination of modalities comprising tables and passages. In a non-limiting example, in the realm of natural language processing (NLP) research, the Chinese language is considered a low-resource language as compared to the English language because few passages and even fewer tables in the Chinese language exist in publicly available databases. Thus, it is challenging for NLP algorithms to generate question-answer pairs given tables in the Chinese language due to lack of training data available on tables in the Chinese language. Similarly, a question generation system that is trained to generate questions in the French language given passages in the French language, can find it difficult to generate questions given tables in the French language due to lack of training data available on tables in the French language.

In some cases, such systems/techniques cannot generate multilingual and multimodal questions despite being pretrained on a large amount of data. In a non-limiting example, it was experimentally observed that when prompted to generate a question on a table and a passage in the English language, some existing systems generated the question while referring to only the passage and not the table. Furthermore, when prompted to generate a question on a table and a passage in a different language (e.g., Hindi), the existing systems generated the question while referring to the passage and the title of the table, without accounting for the contents of the table. Thus, a unified question generation system that can generate multilingual questions over tables, passages and/or combinations of tables and passages is desirable. Additionally, there exists an immediate need in the table-text research space for an effective question generation technique over tables and passages that can help in domain adaptation, and that can provide an effective multilingual table question generation (table QG) system.

Various embodiments of the subject innovation can address these issues in the prior art. Embodiments described herein include systems, computer-implemented methods, apparatus and computer program products that enable a unified question generation system that can leverage a unified training strategy across modalities (e.g., tables, passages, combinations of tables and passages) to generate multilingual and multimodal questions. The unified question generation system can be modality neutral and language neutral, such that the unified question generation system can generate questions in a language (e.g., Chinese language) given a modality (e.g., tables, passages, combinations of tables and passages) in the language without requiring training data specific to a combination of the modality and the language (e.g., tables in the Chinese language, passages in the Chinese language). The unified question generation system can employ a unified question generation model to generate the multilingual and multimodal questions. In a non-limiting example, a transformer generator/multilingual transformer (e.g., mT5 model) can be trained on passages in the Chinese language, such that it can generate questions in the Chinese language from tables in the Chinese language, without having encountered tables in the Chinese language during training. Thus, the unified question generation system can transfer to language and modality alike.

Further, the unified question generation system can assist in improving training of table question answering (table QA) models. Question generation can act as a self-supervision tool for question answering (QA) systems. Table QA models can be data hungry and require plenty of training to learn a good model capable of answering a range of queries. The unified question generation system can assist table QA models in question generation tasks over tables from unseen domains (e.g., not readily available in public datasets) such as finance, aviation, medicine, etc. by providing the necessary amount of training data. In a non-limiting example, when a QA system attempts to shift from an existing domain to a new domain in the absence of training data specific to the new domain, the unified question generation system can generate QA pairs that can be used to train existing QA pairs on the other domain to improve performance of the QA system. Upon experimental evaluation of table QA systems with table QG, it was observed that fine tuning QA pairs generated by a table QA system with table QG can improve performance of the table QA system. Additional heuristics can further improve the performance of the table QA system. Table 1 and table 2 provide some values from the experimental evaluation. As evident from the tables, a base performance score of a QA system on a domain (e.g., politics, culture, etc.) can be improved with the addition of question generation.

TABLE 1
Evidence of question generation for domain adaptation

| Topic | Base | Base + QG | Final |
|---|---|---|---|
| Politics | 61.71 | 64.26 | 70.22 |
| Culture | 64.89 | 69.32 | 72.63 |
| Sports | 62.10 | 63.03 | 66.5 |
| People | 60.34 | 63.10 | 70.87 |
| Misc | 61.85 | 64.31 | 69.60 |

TABLE 2
Evidence of question generation for domain adaptation

| Topic | Base | Base + QG | Final |
|---|---|---|---|
| Politics | 40.52 | 41.55 | 43.79 |
| Culture | 36.03 | 38.49 | 39.50 |
| Sports | 37.55 | 37.93 | 41.50 |
| People | 35.94 | 37.42 | 39.33 |
| Misc | 38.58 | 41.10 | 42.23 |

The unified question generation system can also assist in query completion/suggestion tasks. Query completion can help users frame better queries that are guaranteed to return results, help users type less by reducing typing efforts for users, and reduce an error rate for query completion tasks. Since questions can have precomputed answers, the unified question generation system can also save computing time for users. Thus, by employing the unified question generation model and a question generation mechanism that does not differentiate between modalities, the unified question generation system can generate multilingual and multimodal questions to solve one or more problems in the prior art.

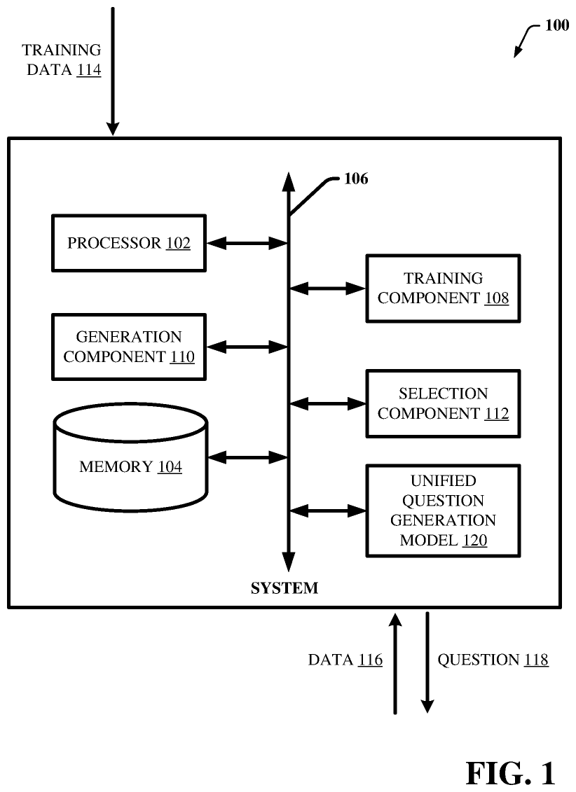

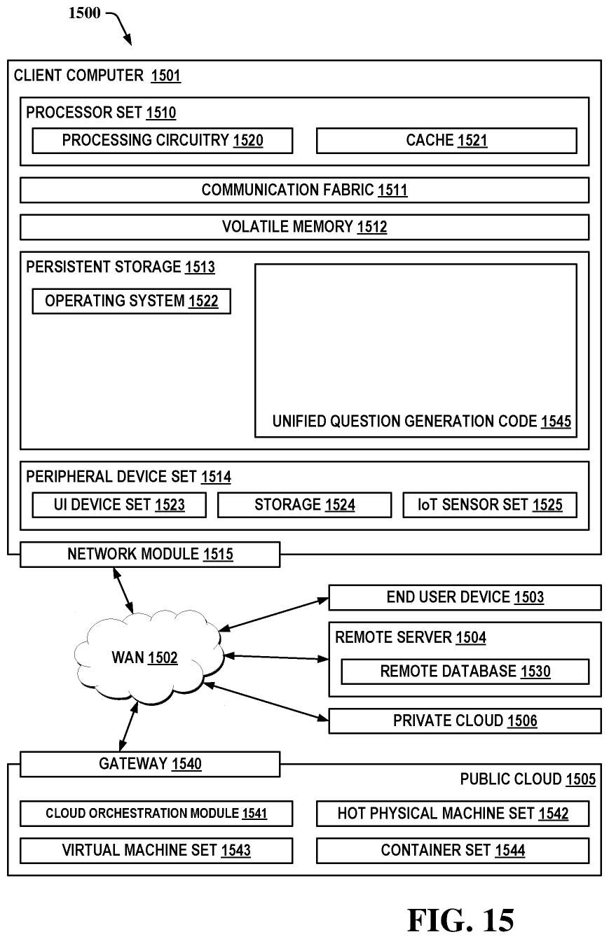

The embodiments depicted in one or more figures described herein are for illustration only, and as such, the architecture of embodiments is not limited to the systems, devices and/or components depicted therein, nor to any particular order, connection and/or coupling of systems, devices and/or components depicted therein. For example, in one or more embodiments, the non-limiting systems described herein, such as non-limiting system 100 as illustrated at FIG. 1, and/or systems thereof, can further comprise, be associated with and/or be coupled to one or more computer and/or computing-based elements described herein with reference to an operating environment, such as the operating environment 1500 illustrated at FIG. 15. In one or more described embodiments. computer and/or computing-based elements can be used in connection with implementing one or more of the systems, devices, components and/or computer-implemented operations shown and/or described in connection with FIG. 1 and/or with other figures described herein.

FIG. 1 illustrates a block diagram of an example, non-limiting system 100 that can build a unified question generation system for generating multilingual and multimodal questions in accordance with one or more embodiments described herein. System 100 can comprise processor 102, memory 104, system bus 106, training component 108, generation component 110, selection component 112 and unified question generation model 120.

The system 100 and/or the components of the system 100 can be employed to use hardware and/or software to solve problems that are highly technical in nature (e.g., related to machine learning, multilingual and multimodal question generation, transfer learning, etc.), that are not abstract and that cannot be performed as a set of mental acts by a human. Further, some of the processes performed may be performed by specialized computers for carrying out defined tasks related to machine learning/question generation. The system 100 and/or components of the system can be employed to solve problems in the fields of information retrieval/question generation. The system 100 can provide unified question generation across modalities via a unified training strategy based on transfer learning to generate cross lingual and cross modal questions, assist in building unified information retrieval/question generation toolkits as a differentiator (e.g., PrimeQA), improving question generation across different contexts for QA domain adaptation over client documents (e.g., tables and text), and/or query completion/suggestion tasks, etc.

Discussion turns briefly to processor 102, memory 104 and bus 106 of system 100. For example, in one or more embodiments, the system 100 can comprise processor 102 (e.g., computer processing unit, microprocessor, classical processor, and/or like processor). In one or more embodiments, a component associated with system 100, as described herein with or without reference to the one or more figures of the one or more embodiments, can comprise one or more computer and/or machine readable, writable and/or executable components and/or instructions that can be executed by processor 102 to enable performance of one or more processes defined by such component(s) and/or instruction(s).

In one or more embodiments, system 100 can comprise a computer-readable memory (e.g., memory 104) that can be operably connected to the processor 102. Memory 104 can store computer-executable instructions that, upon execution by processor 102, can cause processor 102 and/or one or more other components of system 100 (e.g., training component 108, generation component 110, selection component 112 and unified question generation model 120) to perform one or more actions. In one or more embodiments, memory 104 can store computer-executable components (e.g., training component 108, generation component 110, selection component 112 and unified question generation model 120).

System 100 and/or a component thereof as described herein, can be communicatively, electrically, operatively, optically and/or otherwise coupled to one another via bus 106. Bus 106 can comprise one or more of a memory bus, memory controller, peripheral bus, external bus, local bus, and/or another type of bus that can employ one or more bus architectures. One or more of these examples of bus 106 can be employed. In one or more embodiments, system 100 can be coupled (e.g., communicatively, electrically, operatively, optically and/or like function) to one or more external systems (e.g., a non-illustrated electrical output production system, one or more output targets, an output target controller and/or the like), sources and/or devices (e.g., classical computing devices, communication devices and/or like devices), such as via a network. In one or more embodiments, one or more of the components of system 100 can reside in the cloud, and/or can reside locally in a local computing environment (e.g., at a specified location(s)).

In addition to the processor 102 and/or memory 104 described above, system 100 can comprise one or more computer and/or machine readable, writable and/or executable components and/or instructions that, when executed by processor 102, can enable performance of one or more operations defined by such component(s) and/or instruction(s). System 100 can be associated with, such as accessible via, a computing environment 1500 described below with reference to FIG. 15. For example, system 100 can be associated with a computing environment 1500 such that aspects of processing can be distributed between system 100 and the computing environment 1500.

System 100 can enable building a unified question generation system that, given a corpus [symbol] tables [symbol] and passages [symbol] , can generate multilingual questions across all combinations of artifacts comprising tables and passages (e.g., on tables, on passages and on combinations of tables and passages). Training component 108 can train unified question generation model 120 to generate questions (e.g., one or more questions, question 118) in a language from a first modality in the language using training data comprising one or more second modalities in the language different from the first modality, wherein the first modality and the one or more second modalities can include at least one of one or more tables, one or more passages, or a combination of the one or more tables and the one or more passages. In a non-limiting example, training data 114 can comprise publicly available training data including multilingual and monolingual machine reading comprehension (MRC) datasets. Training data 114 can comprise datasets of various modalities such as document datasets, multi-hop QA datasets, tabular datasets and/or hybrid datasets. Unified question generation model 120 can generate the questions without requiring a fixed template and without requiring training specific to one or more domains.

In one or more embodiments, generation component 110 can generate a unified graph representation of data comprised in the one or more second modalities, wherein a controlled subgraph of the unified graph representation can act as an input to unified question generation model 120 for generating a question. Unified question generation model 120 can be trained on question generation via transfer learning by using the unified graph representation and the controlled subgraph to represent information from training data 114, wherein training data can comprise both tables and passages. Unified question generation model 120 can be prefixed with a task prefix and training data 114 can be assigned the same task prefix such that upon encountering training data 114, unified question generation model 120 can recognize a task to be executed. As such, unified question generation model 120 can become trained on training data 114 while being trained for a question generation task, which can enable transfer learning for unified question generation model 120. Based on the training, unified question generation model 120 can generate multilingual questions in multiple modalities, despite unavailability of datasets in certain modalities in training data 114. In a non-limiting example, data 116 comprising a table in a language can be supplied to unified question generation system, and unified question generation model 120 can generate question 118 based on the table, despite being trained only on passages in the language. In one or more embodiments, system 100 can be the unified question generation system enabled by one or more components of system 100.

In one or more embodiments, generation component 110 can generate a modality neutral reasoning path from the data comprised in the one or more second modalities, wherein the modality neutral reasoning path can act as the input to unified question generation model 120 for generating the question. Document datasets, multi-hop QA datasets, tabular datasets, and hybrid datasets (e.g., combinations of tables and passages) can be used as individually modalities to train unified question generation model 120. Based on the respective modalities of training data 114, selection component 112 can select respective entities for generation of respective reasoning paths. Selection component 112 can select a sentence, multiple sentences, an SQL query, or a hybrid chain as the entity for generation component 110. Selection component 112 can select a sentence containing an answer to generate the modality neutral reasoning path when unified question generation model 120 generates the question from textual data. Selection component 112 can select a plurality of sentences containing the answer to generate the modality neutral reasoning path when generating the question requires multi-hop reasoning over the plurality of sentences to generate the answer. Selection component 112 can select a logical form/structured query language (SQL) query that can generate the answer upon execution of the SQL query to generate the modality neutral reasoning path when unified question generation model 120 generates the question from tabular data. Selection component 112 can generate a hybrid chain to generate the modality neutral reasoning path when unified question generation model 120 generates the question from a combination of textual data and tabular data.

Generation component 110 can generate the respective reasoning paths based on the respective entities. Depending on a modality of training data 114, selection component 112 can be a sentence selector, multiple sentence selector, SQL sampler or hybrid chain sampler. Likewise, generation component 110 can be a uniform path converter that can convert an entity from a dataset to a reasoning path based on a modality of the dataset. As such, unified question generation model 120 can become trained on training data 114 while being trained for a question generation task, which can enable transfer learning for unified question generation model 120. Based on the training. unified question generation model 120 can generate multilingual questions in multiple modalities. despite unavailability of datasets in certain modalities in training data 114. In a non-limiting example, data 116 comprising a table in a language can be supplied to unified question generation system, and unified question generation model 120 can generate question 118 based on the table, despite being trained only on passages in the language. In one or more embodiments, system 100 can be the unified question generation system enabled by one or more components of system 100.

The one or more embodiments discussed herein can employ algorithms with a unified design to enable unifying data representations across modalities in a training strategy and to enable common representations of question generation contexts that can help in transfer learning to enable knowledge transfer between modalities (e.g., from passages to tables) or from one language to another. The algorithms discussed herein can also enable sampling reasoning paths and generating natural language (NL) questions from reasoning paths for effective question generation over tables and text. In one or more embodiments, training data 114 can be designed to enable the unified question generation system to be language neutral and modality neutral.

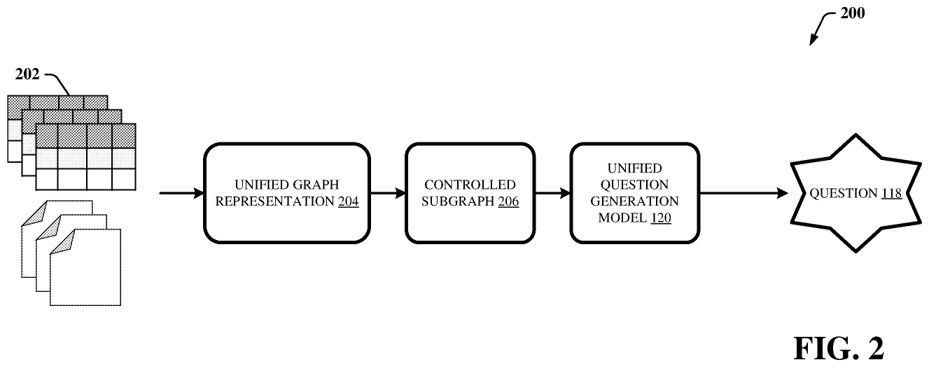

FIG. 2 illustrates an example, non-limiting pipeline 200 for building a unified question generation system that can generate multilingual and multimodal questions in accordance with one or more embodiments described herein. Repetitive description of like elements and/or processes employed in respective embodiments is omitted for sake of brevity.

In one or more embodiments, pipeline 200 can be a machine learning pipeline that can enable a unified question generation system for generating multilingual and multimodal questions. It is to be appreciated that pipeline 200 can enable a first architecture for building the unified question generation system in accordance with the one or more embodiments discussed herein. In a non-limiting example, data 202 can comprise information/world knowledge from datasets in the form of one or more tables and a corpus of passages (e.g., training data 114). Generation component 110 can generate unified graph representation 204 based on data 202. Unified graph representation 204 can represent the information from the one or more tables and the corpus of passages comprised in data 202 in the form of a unified graph (e.g., unified graph [symbol] ). Subsequently, a controlled graph sampler or generation component 110 can generate a subgraph (e.g., subgraph [symbol] , controlled subgraph 206) from unified graph representation 204 via rule-based and statistical sampling. Unified graph representation 204 can provide a multimodal functionality to the unified question generation system by representing information from data 202 as a holistic view of data 202. Thus, although data 202 can comprise information in the form of multiple modalities (e.g., one or more tables and a corpus of passages), the information can be propagated in a unified format along pipeline 200, which can enable the unified question generation system to become modality neutral towards the information.

The controlled graph sampler or generation component 110 can perform graph sampling on unified graph representation 204 to generate controlled subgraph 206, wherein controlled subgraph 206 can be specific to a question (e.g., question 118) that the unified question generation system needs to generate. In a non-limiting example, unified graph representation 204 can comprise all tabular and textual information from data 202 in the form of a unified graph comprising multimodal nodes. Controlled subgraph 206 can comprise a portion of the tabular and textual information from data 202 that can be specific to the question to be generated, wherein controlled subgraph 206 can be sampled by zooming in on a portion of the unified graph. In one or more embodiments, each sampled subgraph can represent respective QA chains over multimodal inputs (e.g., [symbol] ←→QA chain).

Sub-graph sampling performed on unified graph representation 204 to generate controlled subgraph 206 can be statistical or rule-based, wherein the rules can suggest typical entities that the controlled subgraph sampler or generation component 110 can look for when attempting to sample controlled subgraph 206 for a question generation task. The subgraph sampling can require control parameters to be defined for controlling the subgraph to be sampled. In a non-limiting example, the control parameters can comprise information about number of nodes (K) in the subgraph, a type of reasoning chain, complexity of the question to be generated (e.g., whether the question generation task requires multi-hop traversal to reach a question node or single-hop traversal to reach the question node), and a type of answer entity (etype) associated with the question generation task (e.g., whether an entity being generated as part of the question generation task has a numeric entity as an answer, a named entity as the answer, a phrase as the answer, etc.). Herein, it is to be appreciated that ‘reasoning chain’ has been used synonymously as a reasoning chain where the idea is to find a connected path with nodes important for the QA pair generation. Based on the control parameters, the subgraph sampling can further comprise performing standard named entity recognition (NER) to sample an entity (e.g., a target answer node) in the unified graph [symbol] such that the NER of the entity matches the type of answer entity for which the subgraph is sampled. This is further described by equation 1.

Equation 1: NER (ans_e)=etype, wherein ans_e can represent the target answer node and etype can represent the type of answer entity for which the subgraph can be sampled.

After performing the NER, the subgraph sampling comprises finding a walk W of length≤K, such that a destination node e in the subgraph can be reached withing K hops, wherein K can represent the number of nodes in the subgraph and e can represent ans_e. Finding the walk W can result in generation of subgraph [symbol] (e.g., such that subgraph [symbol] unified graph [symbol] ). Controlled subgraph 206 can be an input for unified question generation model 120 to generate question 118. Unified question generation model 120 can be an mT5 model which is a multilingual version (e.g., as represented by the prefix ‘m’) of a text-to-text transfer transformer (T5), wherein T5 is a sequence-to-sequence generation model. For each walk W, an mT5 model can be trained to generate one or more questions based on controlled subgraph 206 and an answer entity, causing the mT5 model to acquire training on data 202 in the process. In a non-limiting example, the mT5 model can be trained on different task prefixes such that the mT5 model can generate a question Q based on subgraph [symbol] and the target answer node ans_e (e.g., training an mT5 for < [symbol] , ans_e>:->Q). A training process for the mT5 model has been discussed in greater detailed in subsequent figures.

Training data (e.g., data 202, training data 114) used to train the unified question generation model 120 can comprise a collection of publicly available training data including multilingual and monolingual machine reading comprehension (MRC) datasets such as Stanford Question Answering Dataset (SQUAD), Cross-lingual Question Answering Dataset (XquAD), Typologically Diverse Question Answering (TyDi QA), etc. and multimodal datasets such as HybridQA, Tabular and Textual dataset for Question Answering (TAT-QA), etc. that can be used for different purposes. XquAD is a multilingual version of the SquAD dataset and TyDi QA is a multilingual version of another MRC dataset. Training data 114 can be fed to the mT5 model in a unifying graph format (e.g., unified graph representation 204) to enable transfer learning. The training datasets used to train the unified question generation model 120 can comprise translations from human annotators as opposed to blackbox translators. Thus, the unified question generation model 120 can be trained without the use of blackbox translations and on multimodal datasets (e.g., TyDi QA can be used for training the mT5 model to parse text in the Chinese language or the French language since TyDi QA comprises passages in the Chinese language and the French language).

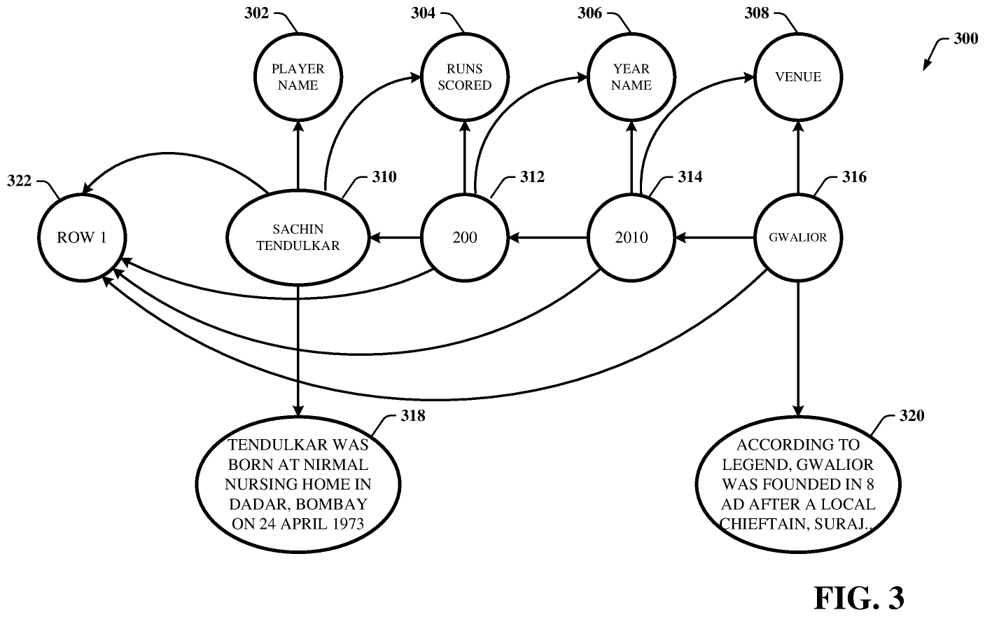

FIG. 3 illustrates an example, non-limiting unified graph 300 of a unified graph representation in accordance with one or more embodiments described herein. Repetitive description of like elements and/or processes employed in respective embodiments is omitted for sake of brevity.

In one or more embodiments, unified graph representation 204 (FIG. 2) can represent information/world knowledge from the one or more tables and the corpus of passages comprised in data 202 (FIG. 2) in the form of a unified graph 300. In a non-limiting example, unified graph 300 can comprise node 302, node 304, node 306, node 308, node 310, node 312, node 314, node 316, node 320 and node 322, wherein each node can represent a sentence from a passage or individual cells in a table. Node 310 can contain the name of a famous cricket player named Sachin Tendulkar. Node 322 can indicate the number of the row where the name Sachin Tendulkar appears in the table. Node 310 can be connected to node 322 which can indicate that the name Sachin Tendulkar appears in row 1 of the table. Further, node 310, node 312, node 314 and node 316 can be connected to each other and to node 322 which can indicate that node 310, node 312, node 314 and node 316 can be cells in row 1 in the table.

Node 302, node 304, node 306 and node 308 can indicate column headings for the respective cells of row 1. In a non-limiting example, node 302 can be a ‘player name’ column, node 304 can be a ‘runs scored’ column, node 306 can be a ‘year name’ column and node 308 can be a ‘venue’ column. Thus, individual rows in the table can indicate number of runs scored by a cricket player in a particular year and at a particular venue. The arrows connecting individual nodes in unified graph 300 can represent the row-wise and column-wise relationships between the individual cells of the table. Further, node 318 can comprise a sentence from a passage that can provide additional information about Sachin Tendulkar, and node 320 can comprise a sentence from a passage that can provide additional information about the city of Gwalior in India, wherein node 318 and node 320 can be connected to the other nodes of unified graph 300. In other words, at instances when the table/tabular information makes one or more references to passages/textual information, the one or more references can be illustrated via respective nodes in unified graph 300.

Thus, unified graph 300 illustrates a connected graph wherein it can be possible to traverse from node 310 to node 316 to ask the question: ‘What was the venue where Sachin Tendulkar scored a double century?’ and arrive at the answer: ‘Gwalior.’ The graph view of unified graph 300 illustrated in FIG. 3 can be generated (e.g., by generation component 110) by splitting rows of a table into cells and splitting passages into sentences. Thereafter, individual cells can be linked to one another, and sentences of a passage can be linked to the individual cells. It is to be appreciated that unified graph 300 is exemplary and may not illustrate a complete graph since all connections between pairs of nodes in unified graph 300 are not shown (e.g., node 318 and node 320 are not shown to be linked with each other). It is to be further appreciated that the one or more embodiments discussed herein with reference to the unified graph or the controlled subgraph are non-limiting. As such, the unified graph or the controlled subgraph can be created with different views than illustrated herein.

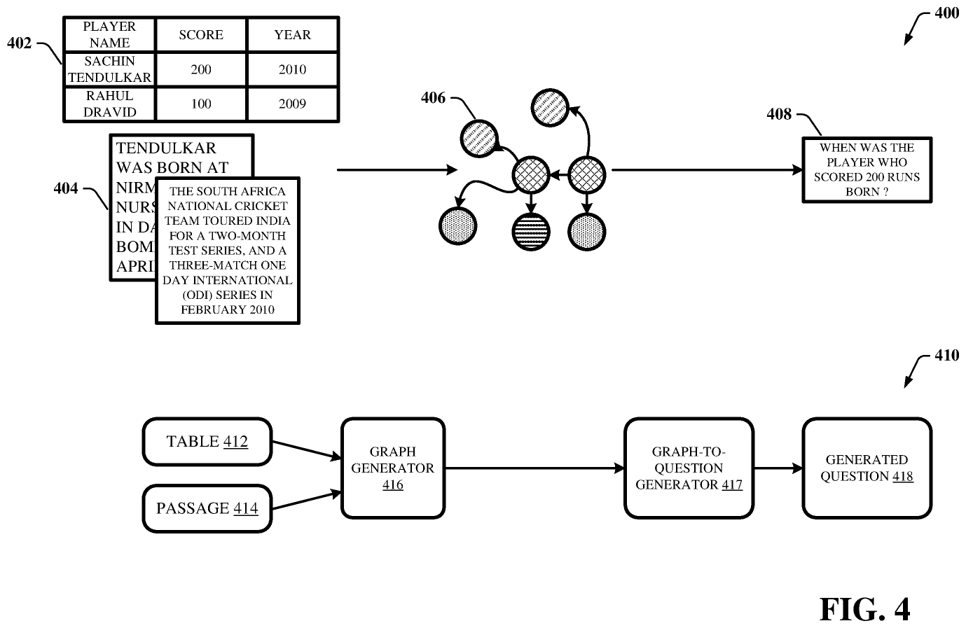

As discussed in one or more embodiments, a controlled graph sampler can sample a subgraph (e.g., controlled subgraph 206) from unified graph 300 to generate a question. Sampling the subgraph can happen via a term frequency-inverse document frequency (TF-IDF) search. TF-IDF can assist a user/entity to search for documents given some keywords. The process of generating the subgraph can begin by identifying an answer node within unified graph 300. Out of all other nodes connected to the answer node (e.g., the answer node can be connected to n nodes, wherein n can be an integer), a node that best satisfies the TF-IDF criteria for generating a question can be selected (e.g., by selection component 112) to generate the subgraph in K number of hops. In a non-limiting example, TF-IDF can be used to generate a subgraph for the question generated at 408 in FIG. 4. Thus, given a graph (e.g., unified graph 300) and a question, walks (e.g., walks of length W) can be generated, wherein generating the walks can comprise creating a chain from the answer node by using a TF-IDF score between the chain and the answer node to decide upon the next hop and additionally, by using beam search.

In one or more embodiments, the question to be generated can be a single-hop question or a multi-hop question. In a non-limiting example, with reference to unified graph 300, the question: ‘Who scored a double century (200 runs)?’ can be a single-hop question since node 312 describing the number of runs is directly connected to node 310 (e.g., the answer node) describing the cricket player who scored the double century. Likewise, the question: ‘Where was the cricket player, who scored the double century, born?’ can be a multi-hop question since node 312 describing the number of runs is directly connected to node 318 (e.g., the answer node) describing a birthplace of the cricket player who scored the double century. In this scenario, node 310 can be an implicit node since node 318 (e.g., the answer node) is located two hops away from node 312 (e.g., node 312 to node 310 being a first hop and node 310 to node 318 being a second hop).

FIG. 4 illustrates example, non-limiting pipelines 400 and 410 for building a unified question generation system that can generate multilingual and multimodal questions in accordance with one or more embodiments described herein. Repetitive description of like elements and/or processes employed in respective embodiments is omitted for sake of brevity.

In one or more embodiments, pipeline 400 can enable question generation via a unified question generation system in conjunction with the embodiments discussed with reference to FIG. 3. At 406, pipeline 400 can enable generation of a unified graph (e.g., unified graph 300) based on information comprised in table 402 and passages 404 (e.g., training data 114, data 202). The unified graph illustrated at 406 can comprise a variety of nodes (e.g., as indicated by the variety of patterns) which can be indicative of different types of cells (e.g., a cell in row 1 and column 1, a column heading cell, etc.) of table 402 and/or different passages of passages 404. Subsequently, a controlled graph sampler or generation component 110 (FIG. 1) can sample a subgraph (e.g., controlled subgraph 206) from the unified graph based on various controlled parameters (e.g., information about the number of nodes in the subgraph, types of answer entities, etc.).

At 408, pipeline 400 can enable generation of the question: ‘When was the player who scored 200 runs born?’ As discussed in one or more embodiments herein, the unified graph can enable the unified question generation system to be modality neutral at the unified graph representation level (e.g., at 406) by unifying information from various modalities comprised in table 402 and passages 404. Thus, based on the sampled subgraph generated at 406 and an answer entity, a unified question generation model (e.g., unified question generation model 120, mT5 model) can become trained on a large corpus of datasets (e.g., table 402 and passages 404) comprising numerous multilingual and multimodal QA datasets (e.g., all publicly available datasets on table QA, table-plus-text QA, etc.), while being trained for generating the question. The training data being fed to the unified question generation model in a unifying graph format via the subgraph can enable transfer learning for the unified question generation model. This can enable the unified question generation system to generate multimodal and multilingual questions without requiring training specific to a combination of a modality and a language. A training process for the unified question generation model has been discussed in greater detailed in subsequent figures.

Pipeline 410 illustrates an architecture equivalent to pipeline 200 and pipeline 410 wherein table 412 and passage 414 can be supplied to a graph generator 416 (e.g., generation component 110) that can generate a unified graph representation (e.g., unified graph representation 204) of information comprised in table 412 and passage 414. A controlled graph sampler or graph generator 416 can generate a controlled subgraph (e.g., controlled subgraph 206) from the unified graph representation. Based on the controlled subgraph and an answer, a graph-to-question generator 417 (e.g., unified question generation model 120, mT5 model) can be trained to generate question 418.

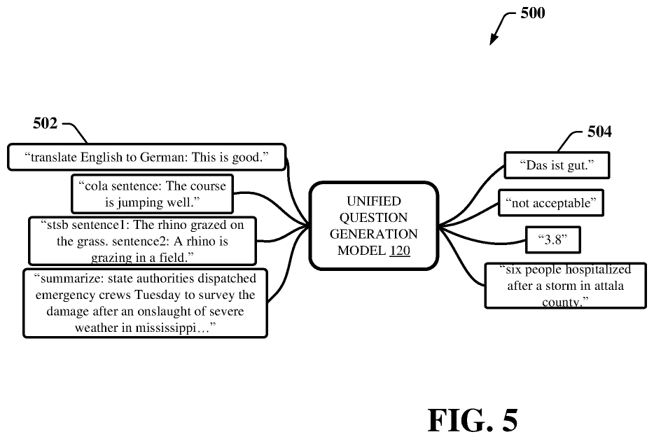

FIG. 5 illustrates an example, non-limiting embodiment 500 for training a unified question generation model in accordance with one or more embodiments described herein. Repetitive description of like elements and/or processes employed in respective embodiments is omitted for sake of brevity.

In one or more embodiments, a unified question generation model (e.g., unified question generation model 120, graph-to-question generator 417) can be trained on a task prefix for generating questions. As discussed in one or more embodiments, unified question generation model 120 can be an mT5 model which is a multilingual sequence-to-sequence generator that can be trained on numerous multilingual and multimodal datasets (e.g., training data 114, data 202) supplied to the mT5 model via a unifying graph representation of the datasets for a question generation task. Specifically, the mT5 model can be trained on a task prefix architecture wherein the mT5 model can be prefixed with a task prefix about a specific question generation task such that upon receiving training data with the same task prefix, the mT5 model can recognize a task (e.g., question generation task) to be performed.

In a non-limiting example, a common task prefix can be used throughout a training process for the mT5 model and across modalities and languages comprised in the training data (e.g., training data 114, data 202), and a sampled subgraph (e.g., controlled subgraph 206) of the training data with the common task prefix can be supplied to the mT5 model to train the mT5 model on the training data for a question generation task. This can enable a uniform training process. A task prefix can be described as a definition of a task (e.g., question generation task). In the non-limiting embodiment 500 illustrated in FIG. 5, unified question generation model 120 can be provided, at 502, with a task prefix (e.g., to translate a sentence from a first language to a second language) and an input (e.g., the sentence to be translated). Based on the task prefix, unified question generation model 120 can generate, at 504, a response (e.g., a translation of the sentence to the second language). Thus, a task prefix can command the mT5 model to perform a specific task based on a specific input.

For a question generation task, unified question generation model 120 can be provided with a task prefix: ‘Generate question from graph.’ Based on the task prefix, unified question generation model 120 can generate a question (e.g., question 118). Thus, the unified question generation model 120 can be trained on the training data (e.g., training data 114) with a task prefix. such that unified question generation model 120 can generate meaningful questions upon encountering multilingual and multimodal inputs. By changing the task prefix at input, unified question generation model 120 can be trained to perform multiple tasks. In an embodiment, unified question generation model 120 can be trained by using a different task prefix for the different types of data.

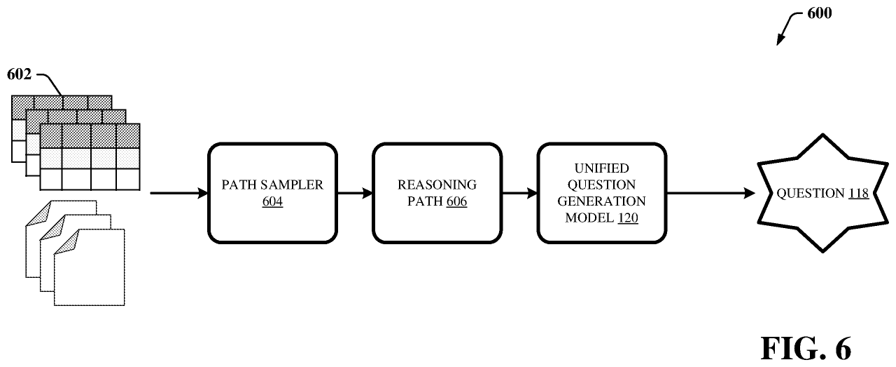

FIG. 6 illustrates an example, non-limiting pipeline 600 for building a unified question generation system that can generate multilingual and multimodal questions in accordance with one or more embodiments described herein. Repetitive description of like elements and/or processes employed in respective embodiments is omitted for sake of brevity.

In one or more embodiments, pipeline 600 can be a machine learning pipeline that can enable a unified question generation system for generating multilingual and multimodal questions. It is to be appreciated that pipeline 600 can enable a second architecture (e.g., as opposed to the first architecture discussed with reference to FIG. 2) for building the unified question generation system in accordance with the one or more embodiments discussed herein. In a non-limiting example, data 602 can comprise information/world knowledge from datasets in the form of one or more tables and/or a corpus of passages (e.g., training data 114). Generation component 110 can generate reasoning path 606 based on data 602, wherein reasoning path 606 can be a modality neutral reasoning path. Path sampler 604 or selection component 112 can sample/select an entity from data 602 based on one or more modalities of the datasets comprised in data 602, for generating reasoning path 606. Path sampler 604 or selection component 112 can sample/select the respective entities via rule-based or statistical sampling. Reasoning path 606 can be an input to unified question generation model 120 for generating a question (e.g., question 118). In pipeline 200, information from datasets (e.g., data 202) can be unified at a knowledge corpus level via unified graph representation 204, whereas in pipeline 600, information from the datasets (e.g., data 602) can be unified at a question generation level. Additional aspects of unifying information within pipeline 600 have been described in subsequent figures.

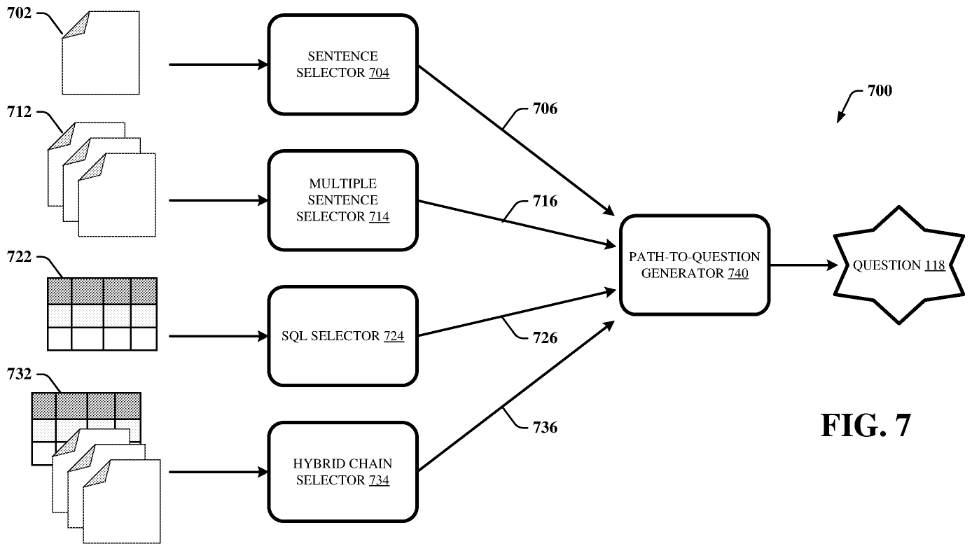

FIG. 7 illustrates an example, non-limiting embodiment 700 for building a unified question generation system that can generate multilingual and multimodal questions in accordance with one or more embodiments described herein. Repetitive description of like elements and/or processes employed in respective embodiments is omitted for sake of brevity.

FIG. 7 elaborates on the training pipeline discussed with reference to FIG. 6 for training the unified question generation system. Datasets comprised in data 602 can initially be treated as separate sources of information based on one or more modalities of the datasets for implementing pipeline 600. In a non-limiting embodiment, data 602 can comprise document datasets 702 (e.g., SQUAD), multi-hop QA datasets 712 (e.g., hotpotQA), tabular datasets 722 (e.g., wikiSQL) and hybrid datasets 732 (e.g., HybridQA), wherein pipeline 600 can enable path-to-question generator 740 (e.g., unified question generation model 120, mT5 model) to be trained on each individual type of dataset (e.g., in contrast to being trained on a unified graph representation of information from all different modalities of datasets).

When an input comprises document datasets 702, sentence selector 704 (e.g., path sampler 604, selection component 112) can select a sentence containing an answer, at 706, to generate reasoning path 606. When an input comprises multi-hop QA datasets 712, multiple sentence selector 714 (e.g., path sampler 604, selection component 112) can select a plurality of sentences containing the answer, at 716, to generate reasoning path 606, since generating a question from multi-hop QA datasets 712 can require multi-hop reasoning over the plurality of sentences to generate the answer. When an input comprises tabular datasets 722, SQL selector 724 (e.g., path sampler 604, selection component 112) can select an SQL query that generates the answer upon execution of the SQL query, at 726, to generate reasoning path 606. When an input comprises hybrid datasets 732, hybrid chain selector 734 (e.g., path sampler 604, selection component 112) can select a hybrid chain, at 736, to generate reasoning path 606.

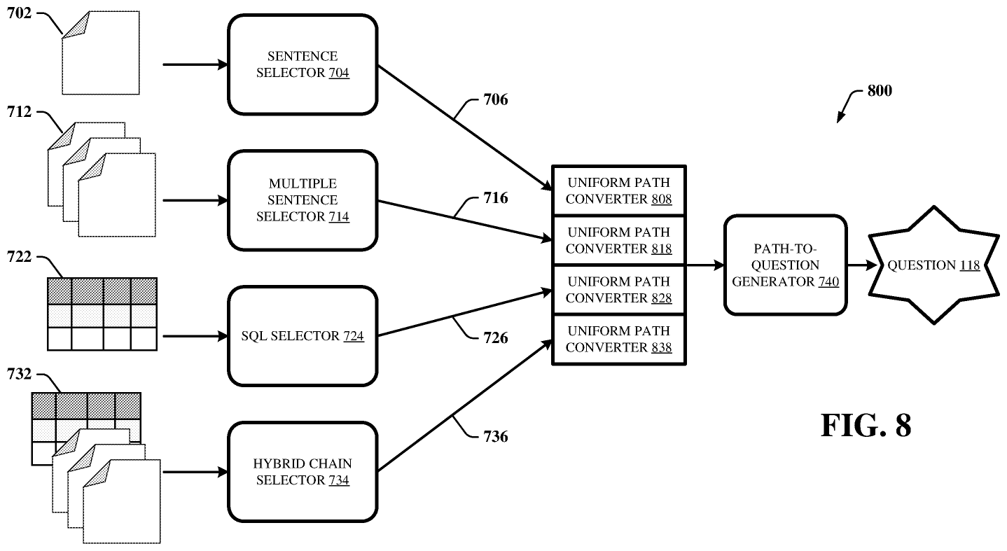

Each individual reasoning path (e.g., reasoning path 606 for respective modalities of datasets) can become a respective unifying point (e.g., similar to unified graph representation 204 in pipeline 200) for training path-to-question generator 740 for generating a question. Each individual reasoning path can be represented in the same (or similar format) to enable training path-to-question generator 740. In a non-limiting example, to enable representing the individual reasoning paths in the same (or similar) format, table cells (e.g., from tabular datasets 722) can be represented in a text format: ‘The column is value.’ This can be achieved via hops (e.g., Hop—(T) Country is Argentina. (T) Captain is Messi. (P) Messi was born in Rosario.) or multiple conditions (e.g., And-(T) Company is XYZ. (T) Office worker is John Smith. (P) John Smith was born in New York). SQL selector 724 can sample/select at SQL query (e.g., at 726) via rule-based or statistical sampling. An example of rule-based sampling for SQL queries can be described with reference to table 3. In a non-limiting example, table 3 can be a tabular dataset supplied to SQL selector 724 for a question generation task. SQL selector 724 can sample SQL queries from table 3 based on defined rules (e.g., SELECT left-office year WHERE Name=Dewitt Clinton and SELECT left-office year WHERE took-office year=1877) to generate a meaningful query. Rule-based sampling can be desirable in situations where SQLs can be unnatural. Statistical sampling can be performed by learning a good distribution of SQL queries (reasoning paths). Further explanation on aspects of training the unified question generation system discussed herein follows with reference to FIG. 8.

TABLE 3
An exemplary table that can be fed to
an SQL sampler (e.g., SQL selector 724)

| Name | Took-office year | Left-office year | Party |
|---|---|---|---|
| John Hancock | 1875 | 1877 | Democrat |
| Dewitt Clinton | 1877 | 1879 | Democrat |
| . . . | . . . | . . . | . . . |

FIG. 8 illustrates an example, non-limiting embodiment 800 for building a unified question generation system that can generate multilingual and multimodal questions in accordance with one or more embodiments described herein. Repetitive description of like elements and/or processes employed in respective embodiments is omitted for sake of brevity.

FIG. 8 describes a uniform path conversion aspect of pipeline 600 used for training path-to-question generator 740 (e.g., unified question generation model 120, mT5 model) to generate multilingual and multimodal questions. In a non-limiting example, subsequent to selection of an entity (e.g., one or more sentences containing an answer, an SQL query, a hybrid chain) by path sampler 604 or selection component 112 based on one or more modalities of input data, a uniform path converter can convert the selected entities into respective reasoning paths (e.g., reasoning path 606). Thus, uniform path converter 808 can perform sentence-to-path conversion for the sentence containing the answer selected at 706, uniform path converter 818 can perform passage-to-path conversion based on the plurality of sentences containing the answer selected at 716, uniform path converter 828 can perform SQL-to-path conversion based on the SQL query selected at 726, and uniform path converter 838 can perform chain-to-path conversion based on the hybrid chain selected at 736.

The path conversion can act as a unifying mechanism along pipeline 600, wherein the one or more sentences, SQL query or hybrid chain can be projected to a path, wherein the path projection can be similar to pre-processing or post-processing splits. As such, the individual reasoning paths can act as a unifying point along pipeline 600, causing the unified question generation system to be modality neutral at the question generation stage (e.g., as opposed to pipeline 200 wherein unification of data can occur at the knowledge source, wherein a manner of representing information from various datasets can make the unified question generation system neutral towards source modalities). A reasoning path (e.g., reasoning path 606) can be an input to path-to-question generator 740 for training the path-to-question generator 740 to generate multilingual and multimodal questions. In a non-limiting example, by unifying information via different reasoning paths, pipeline 600 can train an mT5 model to generate questions in the French language based on tables in the French language, by using only passages in the French language as part of the training data (e.g., training data 114). Additionally, the mT5 model become trained on a large corpus of datasets comprising numerous multilingual and multimodal QA datasets such as document datasets 702, multi-hop QA datasets 712, tabular datasets 722 or hybrid datasets 732, while being trained for question generation tasks.

In one or more embodiments, a unified question generation model (e.g., unified question generation model 120, path-to-question generator 470) can be trained on task prefixes (e.g., as described with reference to FIG. 5) to enable transfer learning for generating multilingual and multimodal. As discussed in one or more embodiments, unified question generation model 120 can be an mT5 model which is a multilingual sequence-to-sequence generator that can be trained on a task prefix architecture wherein the mT5 model can be prefixed with a task prefix about a specific question generation task such that upon receiving training data with the same task prefix, the mT5 model can recognize a task (e.g., question generation task) to be performed. In a non-limiting example, a common task prefix can be used throughout a training process for the mT5 model and across modalities and languages comprised in the training data (e.g., training data 114, document datasets 702, multi-hop QA datasets 712, tabular datasets 722 or hybrid datasets 732), and a reasoning path format for respective reasoning paths can be brought as close to one another as possible, so that a unified training strategy can be adopted for training a question generation module (e.g., unified question generation model 120). This can enable a uniform training process. By changing the task prefix at input, unified question generation model 120 can be trained to perform multiple tasks. In an embodiment, unified question generation model 120 can be trained by using a different task prefix for the different types of data.

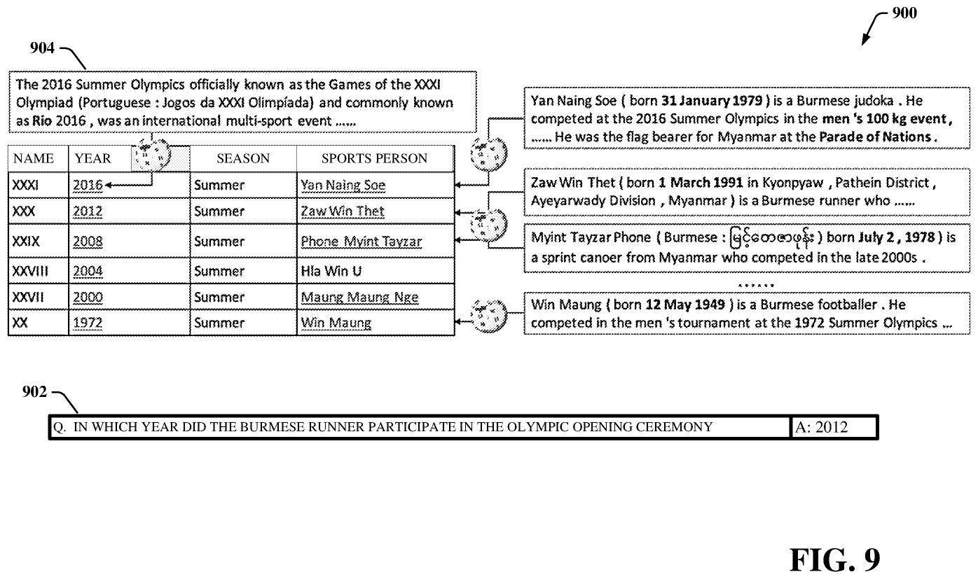

FIG. 9 illustrates an example, non-limiting embodiment 900 of a HybridQA dataset in accordance with one or more embodiments described herein. Repetitive description of like elements and/or processes employed in respective embodiments is omitted for sake of brevity.

As discussed in one or more embodiments, an input comprising hybrid datasets 732 (e.g., HybridQA) can be used to train a unified question generation model 120 by selecting a hybrid chain and converting the hybrid chain to a reasoning path. In a non-limiting example, the HybridQA dataset can comprise table 904, wherein table 904 can be a table (e.g., a Wikipedia table) hyperlinked to passages. It is to be appreciated that table 904 is exemplary and HybridQA can comprise a different table(s). Table 904 can be used to generate a question-answer pair as illustrated at 902.

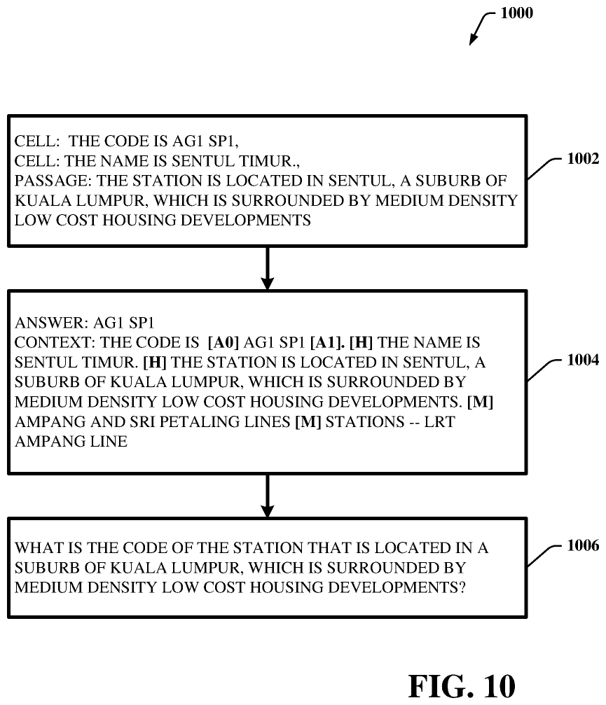

FIG. 10 illustrates a flow diagram 1000 of an example, non-limiting method for generating questions from hybrid chains in accordance with one or more embodiments described herein. Repetitive description of like elements and/or processes employed in respective embodiments is omitted for sake of brevity.

As discussed in one or more embodiments herein, training a unified question generation model (e.g., using pipeline 600) to generate multilingual and multimodal questions from hybrid datasets (e.g., hybrid datasets 732) can comprise selecting a hybrid chain to generate a reasoning path (e.g., reasoning path 606). Finding hybrid chains can require filtering questions for which there is 100 percent (100%) confidence on a position of the answer. Filtering questions can result in fewer but meaningful questions (e.g., 25,000 instances out of 65,000 total instances). A table-plus-text QA model (e.g., HybridQA) can be used to identify correct answers and add them to the set.

Table 4 presents examples of candidate hybrid chains. For generating the question listed in row 1 of table 4, the answer node (e.g., sentence node) can be contained within a sentence from a passage comprised in the hybrid datasets (e.g., as indicated in row 2 of table 4), and the answer node can form a hybrid chain along with two cell nodes. Likewise, for generating the question listed in row 9, the answer node (e.g., cell node) can be contained within a cell of a table comprised in the hybrid datasets (e.g., as indicated in row 10 of table 4), and the answer node can form a hybrid chain along with another cell node and a sentence node.

TABLE 4

| | |
|---|---|
| 1 | Q: After what season did the number 7 competitor retire? |
| 2 | Sentence-node (answer): “He retired at the end of the 2006 season.” |
| 3 | cell-node: “The Rider is Pierfrancesco Chili.” |
| 4 | cell-node: “The No is 7.” |
| 5 | Q: The story of a cab driver witnessing a dangerous situation involving a |
| | kingpin leads to extensive loss in a Bengali language film directed by one of the |
| | leading ad film makers in Kolkata who has made how many ad films in his career? |
| 6 | Sentence-node (answer): “He is one of the leading ad film makers in Kolkata |
| | and has made 450+ ad films.” |
| 7 | cell-node: “The Director is Raja Chanda.” |
| 8 | cell-node: “The Film is Rangbaaz.” |
| 9 | Q: What is the venue that is located in the city with a population 350,616 in 2019? |
| 10 | cell-node (answer): “The Venue is Dinamo Stadium (Brest).” |
| 11 | cell-node: “The Location is Brest.” |
| 12 | Sentence-node: “(Brest-on-the-Bug Polish: Brześć nad Bugiem), is a city |
| | (population 350,616 in 2019) in Belarus at the border with Poland opposite |
| | the Polish city of Terespol, where the Bug and Mukhavets rivers meet.” |

Generating questions from hybrid chains can comprise converting hybrid chains into strings with special token delimiters. Flow diagram 1000 illustrates a hybrid chain at 1002. At 1004, the hybrid chain can be converted to strings with special token delimiters (e.g., [A], [A1], [H], [M]). Strings with the [M] token delimiters can indicate table meta information. At 1006, a unified question generation model (e.g., unified question generation model 120, path-to-question generator 740, mT5 model) can generate the question: ‘What is the code of the station that is located in a suburb of Kuala Lumpur, which is surrounded by medium density low-cost housing developments?’ Table 5 lists additional examples of question generated on a development set (dev set).

TABLE 5
Examples of generating questions on a development set.

| | |
|---|---|
| 1 | Hybrid chain: |
| 2 | Passage: they play their home games at the stade du pairay. |
| 3 | Cell: The Club is R. Francs Borains. |
| 4 | Cell: The Municipality is Boussu. |
| 5 | Ground truth question: What is the home ground of the cub in the municipality of Boussu? |
| 6 | Generated question: Where does the team from Boussu play their home games? |
| 7 | Hybrid chain: |
| 8 | Cell: the date is september 11. |
| 9 | Cell: The Guests/Segments is Meg Ryan and Jon Hamm. |
| 10 | Passage: In 2008, Hamm appeared in a remake of the science fiction film |
| | The Day the Earth Stood Still. |
| 11 | Ground truth question: What is the air date of the guest who appeared in a |
| | remake of the science fiction film The Day the Earth Stood Still? |
| 12 | Generated question: What date did the guest who appeared in a remake of the |
| | science fiction film The Day the Earth Stood Still go on Live with Regis and Kelly? |

Sampling candidate hybrid chains can happen via a term frequency-inverse document frequency (TF-IDF) search. TF-IDF can assist a user/entity to search for documents given some keywords. The process of generating a hybrid chain can begin by identifying an answer node. Out of all other nodes connected to the answer node (e.g., the answer node can be connected to n nodes, wherein n can be an integer), a node that best satisfies the TF-IDF criteria for generating a question can be selected (e.g., by selection component 112). In a non-limiting example, TF-IDF can be used to generate a hybrid chain at 1002 for the question generated at 1006 in FIG. 10. Thus, generating candidate hybrid chains can comprise creating a chain from the answer node by using a TF-IDF score between the chain and the answer node to decide upon the next hop and additionally, by using beam search.

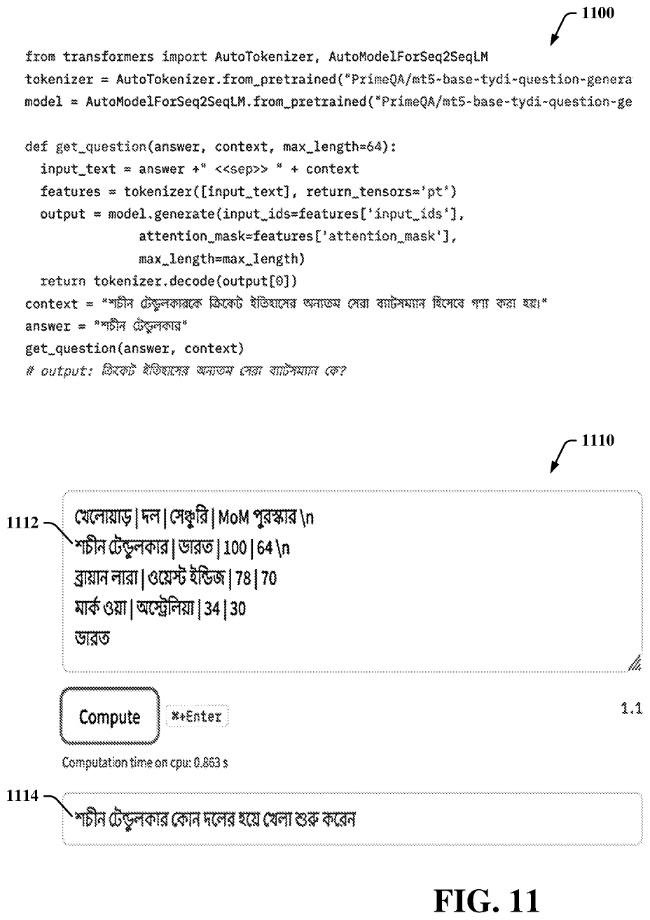

FIG. 11 illustrates an example, non-limiting model 1100 for generating multilingual questions from a table in accordance with one or more embodiments described herein. Repetitive description of like elements and/or processes employed in respective embodiments is omitted for sake of brevity.

FIG. 11 illustrates model 1100, wherein model 1100 (e.g., unified graph generation 204, mT5 model, graph-to-question generator 417) can comprise an algorithm that can enable a unified graph generation system according to a first architecture (e.g., pipeline 200, pipeline 400, pipeline 410) as discussed in one or more embodiments herein. Thus, model 1100 can generate multilingual and multimodal questions based on a unified graph representation (e.g., unified graph representation 204, unified graph 300). In a non-limiting example, it was experimentally observed that model 1100 can generate a question in the Bengali language from a table in the Bengali language, without being trained for generating questions from tables in the Bengali language. Table 1110 can comprise information on cricket players, runs scored by the cricket players, etc. (e.g., similar to FIGS. 3 and 4). Upon feeding table 1110 to model 1100, the model 1100 can generate the question: ‘Which country does Sachin Tendulkar play for?’ in the Bengali language as illustrated at 1114. Model 1100 can use information from row 2 of table 1110 illustrated at 1112, wherein the first two words are ‘Sachin Tendulkar’ in the Bengali language and wherein the third word is ‘India’ in the Bengali language.

Model 1100 can generate the question at 1112 despite not having received any training on question generation from tables in the Bengali language due to lack of tables in the Bengali language in the training corpus. Evidently, the one or more embodiments discussed herein can enable cross lingual and cross modal transfer without requiring training data specific to an input. Sample results based on the question generation example discussed herein are presented in table 6, wherein a quality of the question generated in the Bengali language by model 1100 is compared to that of existing datasets such as the HybridQA dataset and the TyDiQA dataset. The HybridQA dataset is a table-plus-text based multimodal and monolingual dataset, and the rouge course values listed in the first column can indicate the quality of the question generated in the Bengali language by model 1100. Typically, rouge course values above 0.3 can be considered reasonably good. Thus, table 6 can suggest that model 1100 generates good multilingual and multimodal questions via cross lingual and cross modal transfer.

TABLE 6
Rouge course values indicating performance of model
1100 as compared to performance of other datasets for
cross lingual and cross modal question generation.

| Monolingual multimodal: HybridQA | Multilingual text: Tydi QA |
|---|---|
| rouge1 = 0.5579983166290967 | rouge1 = 28.9264 |
| rouge2 = 0.356156415289018 | rouge2 = 17.1576 |
| rougeL = 0.5068710523880764 | rougeL = 28.396 |
| rougeLsum = 0.5075176291230103 | rougeLsum = 28.4241 |

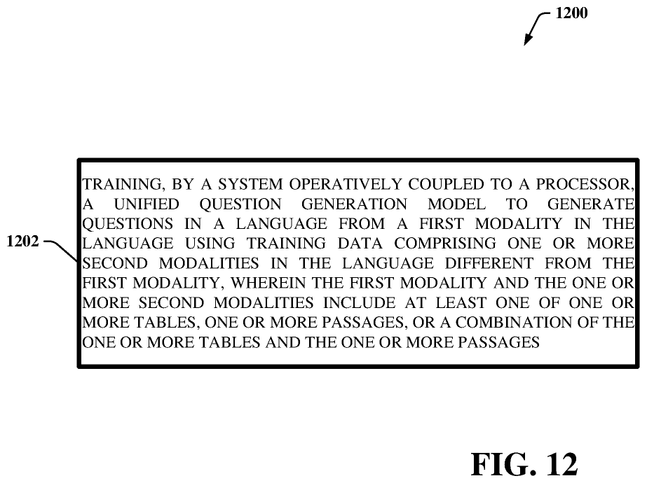

FIG. 12 illustrates an example, non-limiting method 1200 for building a unified question generation model to generate multilingual and multimodal questions in accordance with one or more embodiments described herein. Repetitive description of like elements and/or processes employed in respective embodiments is omitted for sake of brevity.

At 1202, the non-limiting method 1200 can comprise training (e.g., by training component 108), by a system operatively coupled to a processor, a unified question generation model to generate questions in a language from a first modality in the language using training data comprising one or more second modalities in the language different from the first modality, wherein the first modality and the one or more second modalities include at least one of one or more tables, one or more passages, or a combination of the one or more tables and the one or more passages.

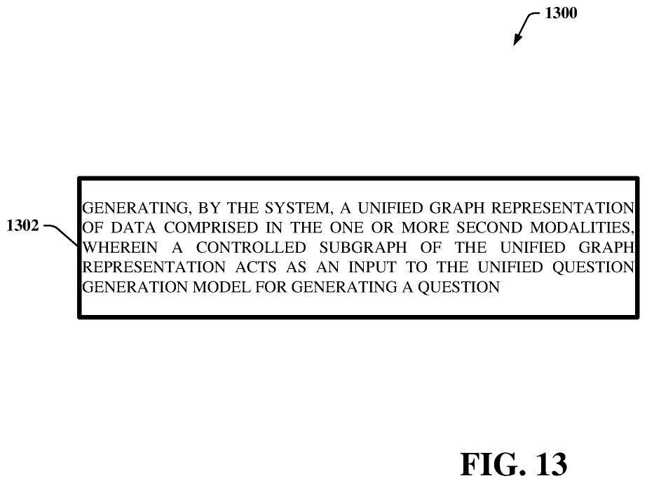

FIG. 13 illustrates an example, non-limiting method 1300 for enabling a first architecture for training a unified question generation model to generate multilingual and multimodal questions in accordance with one or more embodiments described herein. Repetitive description of like elements and/or processes employed in respective embodiments is omitted for sake of brevity.

At 1302, the non-limiting method 1300 can comprise generating (e.g., by generation component 110), by the system (e.g., with reference to FIG. 12), a unified graph representation of data comprised in the one or more second modalities, wherein a controlled subgraph of the unified graph representation acts as an input to the unified question generation model for generating a question.

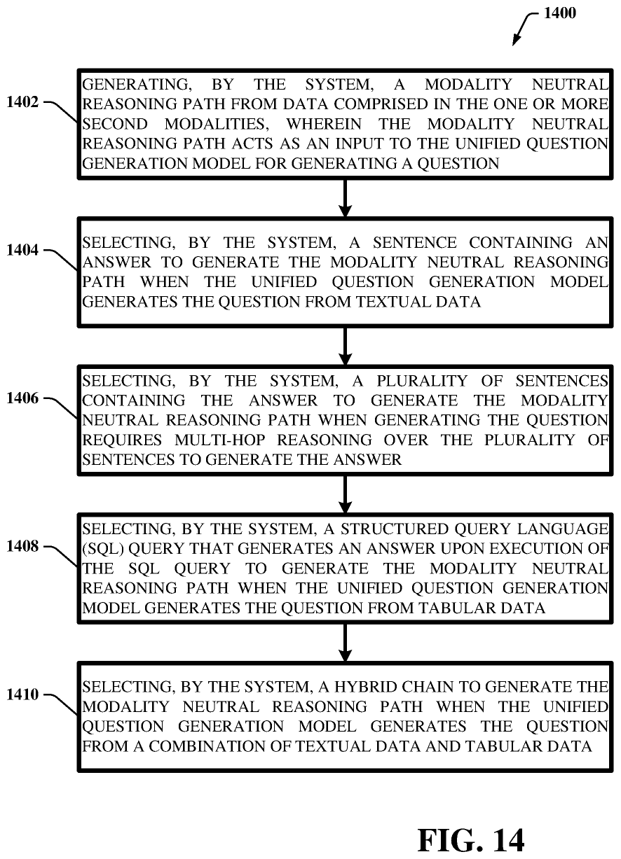

FIG. 14 illustrates a flow diagram of an example, non-limiting method 1400 for enabling a second architecture for training a unified question generation model to generate multilingual and multimodal questions in accordance with one or more embodiments described herein. Repetitive description of like elements and/or processes employed in respective embodiments is omitted for sake of brevity.

At 1402, the non-limiting method 1400 can comprise generating (e.g., by generation component 110), by the system (e.g., with reference to FIG. 12), a modality neutral reasoning path from data comprised in the one or more second modalities, wherein the modality neutral reasoning path acts as an input to the unified question generation model for generating a question.

At 1404, the non-limiting method 1400 can comprise selecting (e.g., by selection component 112), by the system, a sentence containing an answer to generate the modality neutral reasoning path when the unified question generation model generates the question from textual data.

At 1406, the non-limiting method 1400 can comprise selecting (e.g., by selection component 112), by the system, a plurality of sentences containing the answer to generate the modality neutral reasoning path when generating the question requires multi-hop reasoning over the plurality of sentences to generate the answer.

At 1408, the non-limiting method 1400 can comprise selecting (e.g., by selection component 112), by the system, an SQL query that generates an answer upon execution of the SQL query to generate the modality neutral reasoning path when the unified question generation model generates the question from tabular data.

At 1410, the non-limiting method 1400 can comprise selecting (e.g., by selection component 112), by the system, a hybrid chain to generate the modality neutral reasoning path when the unified question generation model generates the question from a combination of textual data and tabular data.

For simplicity of explanation, the computer-implemented and non-computer-implemented methodologies provided herein are depicted and/or described as a series of acts. It is to be understood that the subject innovation is not limited by the acts illustrated and/or by the order of acts, for example acts can occur in one or more orders and/or concurrently, and with other acts not presented and described herein. Furthermore, not all illustrated acts can be utilized to implement the computer-implemented and non-computer-implemented methodologies in accordance with the described subject matter. Additionally, the computer-implemented methodologies described hereinafter and throughout this specification are capable of being stored on an article of manufacture to enable transporting and transferring the computer-implemented methodologies to computers. The term article of manufacture, as used herein, is intended to encompass a computer program accessible from any computer-readable device or storage media.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

One or more embodiments described herein can employ hardware and/or software to solve problems that are highly technical, that are not abstract, and that cannot be performed as a set of mental acts by a human. For example, a human, or even thousands of humans, cannot efficiently, accurately and/or effectively build a unified question generation system that can generate multilingual and multimodal questions without requiring training on specific combinations of languages and modalities as the one or more embodiments described herein can enable this process. And, neither can the human mind nor a human with pen and paper unify information from numerous multimodal and multilingual QA datasets comprising vast amounts of publicly available information to train the unified question generation system to generate multilingual and multimodal questions via transfer learning, as conducted by one or more embodiments described herein.

FIG. 15 illustrates a block diagram of an example, non-limiting, operating environment in which one or more embodiments described herein can be facilitated. FIG. 15 and the following discussion are intended to provide a general description of a suitable operating environment 1500 in which one or more embodiments described herein at FIGS. 1-14 can be implemented.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1500 contains an example of an environment for the execution of at least some of the computer code involved in performing the inventive methods, such as unified question generation code 1545. In addition to block 1545, computing environment 1500 includes, for example, computer 1501, wide area network (WAN) 1502, end user device (EUD) 1503, remote server 1504, public cloud 1505, and private cloud 1506. In this embodiment, computer 1501 includes processor set 1510 (including processing circuitry 1520 and cache 1521), communication fabric 1511, volatile memory 1512, persistent storage 1513 (including operating system 1522 and block 1545, as identified above), peripheral device set 1514 (including user interface (UI), device set 1523, storage 1524, and Internet of Things (IoT) sensor set 1525), and network module 1515. Remote server 1504 includes remote database 1530. Public cloud 1505 includes gateway 1540, cloud orchestration module 1541, host physical machine set 1542, virtual machine set 1543, and container set 1544.

COMPUTER 1501 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1530. As is well understood in the art of computer technology, and depending upon the technology, performance of a computer-implemented method may be distributed among multiple computers and/or between multiple locations. On the other hand, in this presentation of computing environment 1500, detailed discussion is focused on a single computer, specifically computer 1501, to keep the presentation as simple as possible. Computer 1501 may be located in a cloud, even though it is not shown in a cloud in FIG. 15. On the other hand, computer 1501 is not required to be in a cloud except to any extent as may be affirmatively indicated.

PROCESSOR SET 1510 includes one, or more, computer processors of any type now known or to be developed in the future. Processing circuitry 1520 may be distributed over multiple packages, for example, multiple, coordinated integrated circuit chips. Processing circuitry 1520 may implement multiple processor threads and/or multiple processor cores. Cache 1521 is memory that is located in the processor chip package(s) and is typically used for data or code that should be available for rapid access by the threads or cores running on processor set 1510. Cache memories are typically organized into multiple levels depending upon relative proximity to the processing circuitry. Alternatively, some, or all, of the cache for the processor set may be located “off chip.” In some computing environments, processor set 1510 may be designed for working with qubits and performing quantum computing.

Computer readable program instructions are typically loaded onto computer 1501 to cause a series of operational steps to be performed by processor set 1510 of computer 1501 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1521 and the other storage media discussed below. The program instructions, and associated data, are accessed by processor set 1510 to control and direct performance of the inventive methods. In computing environment 1500, at least some of the instructions for performing the inventive methods may be stored in block 1545 in persistent storage 1513.

COMMUNICATION FABRIC 1511 is the signal conduction paths that allow the various components of computer 1501 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1512 is any type of volatile memory now known or to be developed in the future. Examples include dynamic type random access memory (RAM) or static type RAM. Typically, the volatile memory is characterized by random access, but this is not required unless affirmatively indicated. In computer 1501, the volatile memory 1512 is located in a single package and is internal to computer 1501, but, alternatively or additionally, the volatile memory may be distributed over multiple packages and/or located externally with respect to computer 1501.

PERSISTENT STORAGE 1513 is any form of non-volatile storage for computers that is now known or to be developed in the future. The non-volatility of this storage means that the stored data is maintained regardless of whether power is being supplied to computer 1501 and/or directly to persistent storage 1513. Persistent storage 1513 may be a read only memory (ROM), but typically at least a portion of the persistent storage allows writing of data, deletion of data and re-writing of data. Some familiar forms of persistent storage include magnetic disks and solid state storage devices. Operating system 1522 may take several forms, such as various known proprietary operating systems or open source Portable Operating System Interface type operating systems that employ a kernel. The code included in block 1545 typically includes at least some of the computer code involved in performing the inventive methods.

PERIPHERAL DEVICE SET 1514 includes the set of peripheral devices of computer 1501. Data communication connections between the peripheral devices and the other components of computer 1501 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1523 may include components such as a display screen, speaker, microphone, wearable devices (such as goggles and smart watches), keyboard, mouse, printer, touchpad, game controllers, and haptic devices. Storage 1524 is external storage, such as an external hard drive, or insertable storage, such as an SD card. Storage 1524 may be persistent and/or volatile. In some embodiments, storage 1524 may take the form of a quantum computing storage device for storing data in the form of qubits. In embodiments where computer 1501 is required to have a large amount of storage (for example, where computer 1501 locally stores and manages a large database) then this storage may be provided by peripheral storage devices designed for storing very large amounts of data, such as a storage area network (SAN) that is shared by multiple, geographically distributed computers. IoT sensor set 1525 is made up of sensors that can be used in Internet of Things applications. For example, one sensor may be a thermometer and another sensor may be a motion detector.

NETWORK MODULE 1515 is the collection of computer software, hardware, and firmware that allows computer 1501 to communicate with other computers through WAN 1502. Network module 1515 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1515 are performed on the same physical hardware device. In other embodiments (for example, embodiments that utilize software-defined networking (SDN)), the control functions and the forwarding functions of network module 1515 are performed on physically separate devices, such that the control functions manage several different network hardware devices. Computer readable program instructions for performing the inventive methods can typically be downloaded to computer 1501 from an external computer or external storage device through a network adapter card or network interface included in network module 1515.

WAN 1502 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1503 is any computer system that is used and controlled by an end user (for example, a customer of an enterprise that operates computer 1501), and may take any of the forms discussed above in connection with computer 1501. EUD 1503 typically receives helpful and useful data from the operations of computer 1501. For example, in a hypothetical case where computer 1501 is designed to provide a recommendation to an end user, this recommendation would typically be communicated from network module 1515 of computer 1501 through WAN 1502 to EUD 1503. In this way, EUD 1503 can display, or otherwise present, the recommendation to an end user. In some embodiments, EUD 1503 may be a client device, such as thin client, heavy client, mainframe computer, desktop computer and so on.

REMOTE SERVER 1504 is any computer system that serves at least some data and/or functionality to computer 1501. Remote server 1504 may be controlled and used by the same entity that operates computer 1501. Remote server 1504 represents the machine(s) that collect and store helpful and useful data for use by other computers, such as computer 1501. For example, in a hypothetical case where computer 1501 is designed and programmed to provide a recommendation based on historical data, then this historical data may be provided to computer 1501 from remote database 1530 of remote server 1504.

PUBLIC CLOUD 1505 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 1505 is performed by the computer hardware and/or software of cloud orchestration module 1541. The computing resources provided by public cloud 1505 are typically implemented by virtual computing environments that run on various computers making up the computers of host physical machine set 1542, which is the universe of physical computers in and/or available to public cloud 1505. The virtual computing environments (VCEs) typically take the form of virtual machines from virtual machine set 1543 and/or containers from container set 1544. It is understood that these VCEs may be stored as images and may be transferred among and between the various physical machine hosts, either as images or after instantiation of the VCE. Cloud orchestration module 1541 manages the transfer and storage of images, deploys new instantiations of VCEs and manages active instantiations of VCE deployments. Gateway 1540 is the collection of computer software, hardware, and firmware that allows public cloud 1505 to communicate through WAN 1502.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1506 is similar to public cloud 1505, except that the computing resources are only available for use by a single enterprise. While private cloud 1506 is depicted as being in communication with WAN 1502, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1505 and private cloud 1506 are both part of a larger hybrid cloud.

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory. for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a memory that stores computer executable components; and
a processor that executes the computer executable components stored in the memory, wherein the computer executable components comprise:
a training component that trains a unified question generation model to generate questions in a language from a first modality in the language using training data comprising one or more second modalities in the language different from the first modality, wherein the first modality and the one or more second modalities include at least one of one or more tables, one or more passages, or a combination of the one or more tables and the one or more passages.

2. The system of claim 1, further comprising:
a generation component that generates a unified graph representation of data comprised in the one or more second modalities, wherein a controlled subgraph of the unified graph representation acts as an input to the unified question generation model for generating a question.

3. The system of claim 2, wherein the generation component generates a modality neutral reasoning path from the data comprised in the one or more second modalities, wherein the modality neutral reasoning path acts as the input to the unified question generation model for generating the question.

4. The system of claim 3, further comprising:
a selection component selects a sentence containing an answer to generate the modality neutral reasoning path when the unified question generation model generates the question from textual data.

5. The system of claim 4, wherein the selection component selects a plurality of sentences containing the answer to generate the modality neutral reasoning path when generating the question requires multi-hop reasoning over the plurality of sentences to generate the answer.

6. The system of claim 4, wherein the selection component selects a structured query language (SQL) query that generates the answer upon execution of the SQL query to generate the modality neutral reasoning path when the unified question generation model generates the question from tabular data.

7. The system of claim 4, wherein the selection component selects a hybrid chain to generate the modality neutral reasoning path when the unified question generation model generates the question from a combination of textual data and tabular data.

8. The system of claim 1, wherein the unified question generation model generates the questions without requiring a fixed template and without requiring training specific to one or more domains.

9. A computer-implemented method, comprising:
training, by a system operatively coupled to a processor, a unified question generation model to generate questions in a language from a first modality in the language using training data comprising one or more second modalities in the language different from the first modality, wherein the first modality and the one or more second modalities include at least one of one or more tables, one or more passages, or a combination of the one or more tables and the one or more passages.

10. The computer-implemented method of claim 9, further comprising:
generating, by the system, a unified graph representation of data comprised in the one or more second modalities, wherein a controlled subgraph of the unified graph representation acts as an input to the unified question generation model for generating a question.

11. The computer-implemented method of claim 9, further comprising:
generating, by the system, a modality neutral reasoning path from data comprised in the one or more second modalities, wherein the modality neutral reasoning path acts as an input to the unified question generation model for generating a question.

12. The computer-implemented method of claim 11, further comprising:
selecting, by the system, a sentence containing an answer to generate the modality neutral reasoning path when the unified question generation model generates the question from textual data.

13. The computer-implemented method of claim 12, further comprising:
selecting, by the system, a plurality of sentences containing the answer to generate the modality neutral reasoning path when generating the question requires multi-hop reasoning over the plurality of sentences to generate the answer.

14. The computer-implemented method of claim 11, further comprising:
selecting, by the system, a structured query language (SQL) query that generates an answer upon execution of the SQL query to generate the modality neutral reasoning path when the unified question generation model generates the question from tabular data.

15. The computer-implemented method of claim 11, further comprising:
selecting, by the system, a hybrid chain to generate the modality neutral reasoning path when the unified question generation model generates the question from a combination of textual data and tabular data.

16. The computer-implemented method of claim 9, further comprising:
generating, by the system, the questions without requiring a fixed template and without requiring training specific to one or more domains.

17. A computer program product for unified question generation to generate multilingual and multimodal questions, the computer program product comprising a computer readable storage medium having program instructions embodied therewith, the program instructions executable by a processor to cause the processor to:
train, by the processor, a unified question generation model to generate questions in a language from a first modality in the language using training data comprising one or more second modalities in the language different from the first modality, wherein the first modality and the one or more second modalities include at least one of one or more tables, one or more passages, or a combination of the one or more tables and the one or more passages.

18. The computer program product of claim 17, wherein the program instructions are further executable by the processor to cause the processor to:
generate, by the processor, a unified graph representation of data comprised in the one or more second modalities, wherein a controlled subgraph of the unified graph representation acts as an input to the unified question generation model for generating a question.

19. The computer program product of claim 17, wherein the program instructions are further executable by the processor to cause the processor to:
generate, by the processor, a modality neutral reasoning path from data comprised in the one or more second modalities, wherein the modality neutral reasoning path acts as an input to the unified question generation model for generating a question.

20. The computer program product of claim 17, wherein the program instructions are further executable by the processor to cause the processor to:
generate, by the processor, the questions without requiring a fixed template and without requiring training specific to one or more domains.
